(19) United States
(12) Patent Application Publication
(10) Pub. No.: US 2013/0220017 A1
(43) Pub. Date: Aug. 29, 2013

(54) NON-DESTRUCTIVE INSPECTION APPARATUS FOR DETECTING INTERNAL DEFECT OF CONCRETE STRUCTURE USING ULTRASONIC WAVES

(71) Applicants: Sung Kim, (US); Ju-jung Kim, (US)

(72) Inventors: Sung Kim, (US); Ju-jung Kim, (US)

(21) Appl. No.: 13/446,122

(22) Filed: Apr. 13, 2012

(30) Foreign Application Priority Data
Feb. 23, 2012 (KR) 10-2012-0018572

(51) Int. Cl. G01N 29/04; G01N 29/44

(52) U.S. Cl. 73/602; 73/632

(57) ABSTRACT

A non-destructive inspection apparatus for detecting an internal defect in a concrete structure using ultrasonic waves is provided, in which a transmission probe and a reception probe are injected into tubes within a concrete pile, a pulley is connected to the transmission and reception probes by a cable, a drum is connected to the pulley, includes a drum controller, receives data from the transmission and reception probes and the pulley, and conducts wireless communication, and a main body receives a signal from the drum controller of the drum and conducts wireless communication by ZigBee.

### PRIORITY

This application claims priority under 35 U.S.C. §119(a) to a Korean Patent Application filed in the Korean Intellectual Property Office on Feb. 23, 2012 and assigned Serial No. 10-2012-0018572, the contents of which are incorporated herein by reference.

### BACKGROUND OF THE INVENTION

1. Field of the Invention

The present invention relates to a non-destructive inspection apparatus for detecting an internal defect of a concrete structure using ultrasonic waves, and more particularly, to a non-destructive defect inspection apparatus for determining whether there is a defect in the uniformity of the internal concrete of, for example, an about 100-m long post using transmission and reception probes. Ultrasonic speed can be used in determining the presence or absence of a defect in concrete and the strength of the concrete. The presence or absence of a defect in the concrete and the dimensions of the concrete are determined by applying an ultrasonic wave to a target object and measuring the strength and position of a wave reflected from the target object.

2. Description of the Related Art
[Reference 1] Korea Patent No. 10-0478105 (Mar. 11, 2005);
[Reference 2] Korea Patent No. 10-0439334 (Jun. 28, 2004);
[Reference 3] Korea Patent No. 10-0685178 (Feb. 14, 2007); and
[Reference 4] Korea Patent No. 10-0769627 (Oct. 17, 2007).

Ultrasonic non-destructive inspection is a technology which detects the presence or absence of a defect in a target object and the dimensions of the target object by applying an ultrasonic wave to the target object and measuring the strength and position of a wave reflected from the target object. Ultrasonic non-destructive inspection is widely employed in a broad range of applications including all industrial facilities, bridges, tunnels, harbors, repair facilities, engineering structures, and part materials as well as precise diagnosis of construction, repair, and maintenance of bridges and civil engineering structures. For example, the construction state, internal concrete defects and soundness, and concrete strength per position of an on-site installed post, a bulkhead of a caisson, or a mass concrete block can be measured using ultrasonic waves.

The present invention provides a non-destructive concrete inspection apparatus for detecting foreign materials such as mud, sands, and slime, material separation, and pores in concrete based on the principle that ultrasonic waves have a propagation speed of about 3,500 to 4,000 msec at 90 KHz in concrete.

Once the spacing between buried tubes in defectless uniform concrete is determined, an accurate ultrasonic speed can be calculated by dividing the tube spacing by a propagation time. This can be useful when it is used in comparison to the speeds of ultrasonic waves that have passed through concrete. The resulting data may be used significantly in determining the elastic force and density of concrete and thus in effectively measuring the uniformity of the concrete.

As sea structures and land structures have recently become huge, their depths and dimensions have also been increased. Therefore, large-diameter on-site posts are introduced in the designing stage of the structures in order to satisfy the load carrying capacity of posts supporting the structures.

When a concrete pile buried into the ground is tested using a conventional non-destructive concrete inspection apparatus, the concrete pile may be 2 meters or higher above the ground. Therefore, a ladder is required for testing the concrete pile and the testing is difficult due to a communication cable.

Moreover, materials such as ultrasonic-measured data may be defective due to the degradation or cut of a cable used in a field environment, and three or more persons are needed for on-site inspection. Since the conventional ultrasonic non-destructive inspection apparatus needs external AC power for components such as a main board, an external power supply or an electric generator is required. In addition, noise may be introduced to measurements due to external noise introduced from an AC power interface cable and current leakage. It is difficult to move the conventional non-destructive inspection apparatus to a field or any other place for measurement because its main body is large and heavy and peripheral devices are large, such as a communication cable and five cable drums each weighing 20 kg.

Since the conventional non-destructive inspection apparatus simply outputs on-site measurements through a thermal printer, checks the measurements, and stores them, it has limitations in reproduction and simulation. What is worse, the measured data is simply subjected to image processing. As a consequence, much difficulty and inconvenience are involved in evaluating the soundness of concrete and analyzing causes of defects in the concrete.

### SUMMARY OF THE INVENTION

An aspect of embodiments of the present invention is to address at least the problems and/or disadvantages and to provide at least the advantages described below. Accordingly, an aspect of embodiments of the present invention is to enable Radio Frequency (RF) wireless data communication of a system so as to eliminate an interface cable and thus render entire equipment small, low-power operated, and digital. According to the present invention, wireless communication is conducted with a main body using ZigBee.

Considering that Wireless Fidelity (WiFi) suffers from much noise and requires base stations in spite of its advantage of long-distance delivery of communication data, WiFi is not viable for the present invention. On the other hand, Bluetooth has high linearity but operates only within a short range, which makes Bluetooth not feasible for the present invention. In this context, the present invention adopts ZigBee as a wireless communication scheme. Although ZigBee has weak linearity, it offers the benefits of low power, system simplification, and good directionality. The present invention uses ZigBee because ZigBee has no problem with linearity for short-range communication. ZigBee communication has less noise, is less problematic, and enables large-amount data communication.

Because Bluetooth focuses on short-range communication within several meters, it is not applicable to the present invention in view of the nature of equipment of the present invention that requires longer-distance transmission. In contrast, ZigBee facilitates fast communication switching and channel switching between nodes so that each module may be connected to a 16-bit node. Therefore, ZigBee is decided as the best for the present invention.

According to the present invention, ZigBee signals are converted to a clear, noise-free tomographic image (a tomogram), compared to WiFi signals that may not be converted to a clear image due to severe noise.

In ZigBee communication according to the present invention, a large amount of data is not transmitted or received and wireless communication is slow. Thus, when data loss is determined in a transmission and reception check operation using a check signal, the lost data is retransmitted at a next transmission time.

In accordance with an embodiment of the present invention, there is provided a non-destructive inspection apparatus for detecting an internal defect in a concrete structure using ultrasonic waves, in which a transmission probe and a reception probe are injected into tubes within a concrete pile, a pulley is connected to the transmission and reception probes by a cable, a drum is connected to the pulley, and a main body receives a signal from the drum.

The pulley may include a roller that rotates, while supporting the cable, and a remote controller. The cable may include transmission and reception cables connecting the pulley to the transmission and reception probes. The drum may include a drum controller and wirelessly transmit received data to the main body by ZigBee. The main body may display the received data as a tomogram on a screen. The main body may include a main controller having a main board (arm-300 MHz), a power board, an interface board, and a ZigBee RF wireless board, may be configured so as to control the drum and the remote controller and check data, and may display information about the concrete pile as a three-dimensional image. The drum controller may wirelessly transmit acquired data to the main body, check transmission and reception using a check signal, and upon generation of data loss, retransmit lost data at a next transmission time.

### BRIEF DESCRIPTION OF THE DRAWINGS

The above and other objects, features and advantages of certain embodiments of the present invention will be more apparent from the following detailed description taken in conjunction with the accompanying drawings, in which:

FIG. 1 illustrates a system in which a non-destructive inspection apparatus operates according to the present invention;

FIG. 2 illustrates components of the non-destructive inspection apparatus according to the present invention;

FIG. 3 illustrates exemplary basic equipment used in the present invention;

FIG. 4 illustrates an exemplary tomogram of measurements displayed on a main body;

FIG. 5 illustrates an exemplary three-dimensional display of ultrasonic measurements on the main body;

FIG. 6 illustrates exemplary screens that provide noiseless, clear displays of ultrasonic measurements on the body according to the present invention; and

FIG. 7 illustrates another embodiment of transmission and reception probes illustrated in FIG. 1.

Throughout the drawings, the same drawing reference numerals will be understood to refer to the same elements, features and structures.

### DETAILED DESCRIPTION OF EMBODIMENTS OF THE INVENTION

A detailed description of a generally known function and structure of the present invention will be avoided lest it should obscure the subject matter of the present invention. The terms described below are defined in connection with the function of the present invention. The meaning of the terms may vary according to the user, the intention of the operator, usual practice, etc. Therefore, the terms should be defined based on the description rather than the specification.

Among short-range wireless communication technologies, Bluetooth operates within a short range, while Wireless Fidelity (WiFi) operates in a broadband width but suffers from heavy load. A WiFi network is a short-range communication network using radio or infrared communication, usually called ‘Wireless Local Area Network (WLAN)’. Wireless communication is exposed to noise and thus noise interference is a challenging issue to wireless communication. Accordingly, the present invention is intended to reduce noise by ZigBee.

ZigBee is one of the Institute of Electrical and Electronics Engineers (IEEE) 802.15.4 standards supporting short-range communication. ZigBee is a technology for short-range communication within 10 to 20 m and ubiquitous computing in the field of wireless networking in homes or offices. Compared to existing techniques, ZigBee as a concept of a mobile phone or WLAN transmits a small amount of information instead of minimizing power consumption. ZigBee is used in the short-range communication market including an intelligent home network, a building, etc., industrial automation, logistics, environment monitoring, human interfacing, telematics, and military applications. Owing to small size, low power consumption, and inexpensive price, ZigBee has recently attracted much attention as a ubiquitous service solution for a home network, etc.

According to the present invention, wireless ZigBee signals are converted to a tomographic image, with the advantages of ZigBee taken. To transmit a large amount of data wirelessly, conversion of signals to a tomographic image is favorable for output of a noiseless, clear tomogram.

Now a description will be given of the present invention with reference to the attached drawings.

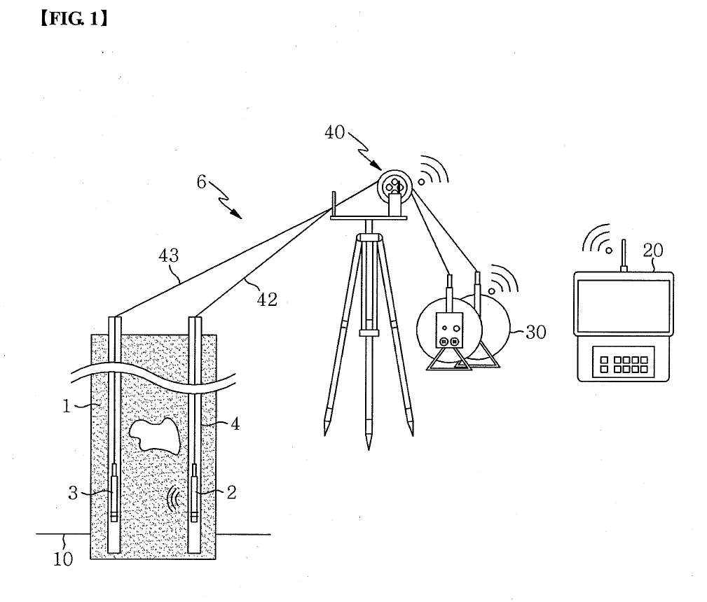

Referring to FIG. 1, a concrete pile 1 is driven into, for example, the ground 10 with bedrock and transmission and reception probes 2 and 3 are installed within the concrete pile 1. In this case, metal tubes 4 are placed into the concrete pile 1 in advance during fabrication of the concrete pile 1.

For probe-based measurement, the tubes 4 are filled with water and the transmission and reception probes 2 and 3 connected to a cable 6 are injected into the tubes 4. Then, measurement is performed by raising the transmission and reception probes 2 and 3 1.25 to 5 cm each time.

The tubes 4 are formed to have as small a diameter as possible, for example, a diameter of about 50 mm. The transmission and reception probes 2 and 3 having a transmitter for generating an ultrasonic signal and a receiver for sensing the ultrasonic signal have a diameter of about 30 mm, for example. The reason for filling water into the tubes 4 is to eliminate noise and increase a communication speed based on the fact that an ultrasonic speed is high in a water medium and thus small propagation energy is consumed.

Sensors are provided inside the transmission and reception probes 2 and 3 and perform measurement by exchanging data with each other, while the transmission and reception probes 2 and 3 are raised by a predetermined unit at each time. That is, the transmission probe 2 is a generation probe that generates an ultrasonic wave at 90 KHz through piezoelectric devices stacked within the transmission probe 2 and tests the soundness of the concrete pile 1 using the ultrasonic wave. For example, four reception probes 3 receive ultrasonic signals from two transmission probes 2 through the concrete pile 1, amplify the received ultrasonic signals, and transmit the amplified ultrasonic signals to a main body 20.

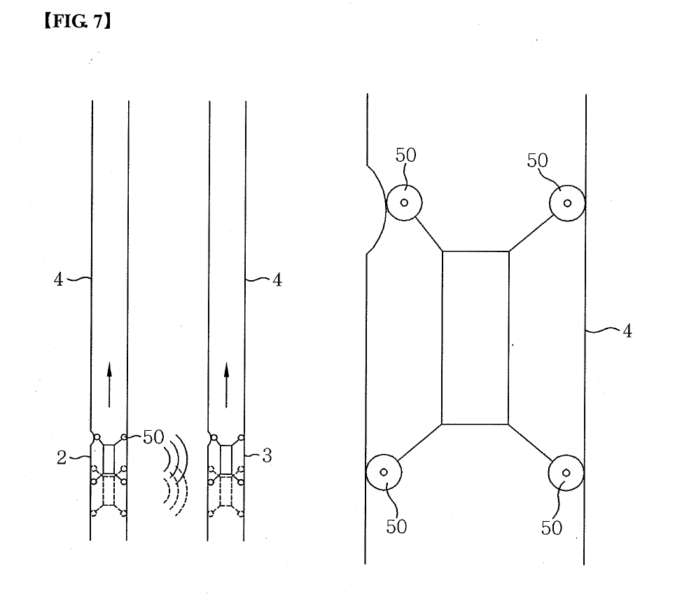

FIG. 7 illustrates another embodiment of the transmission and reception probes 2 and 3.

Referring to FIG. 7, the transmission and reception probes 2 and 3 are configured so as to ascend and descend within the tubes 4 according to the embodiment of the present invention. Wheels 50 are attached to four corners of each of the transmission and reception probes 2 and 3 so that the transmission and reception probes 2 and 3 may rise and fall on their own. Obviously, a small motor and a driver should be provided to the transmission and reception probes 2 and 3 in order to raise and drop the wheels 50.

Meanwhile, rear end portions of the transmission and reception probes 2 and 3 are connected to a cable drum 30 by the cable 6 through a pulley 40. The pulley 40 is configured to wirelessly communicate with a drum board formed on the drum 30. Thus the pulley 40 transmits depth information measured by the transmission and reception probes 2 and 3 in the following method.

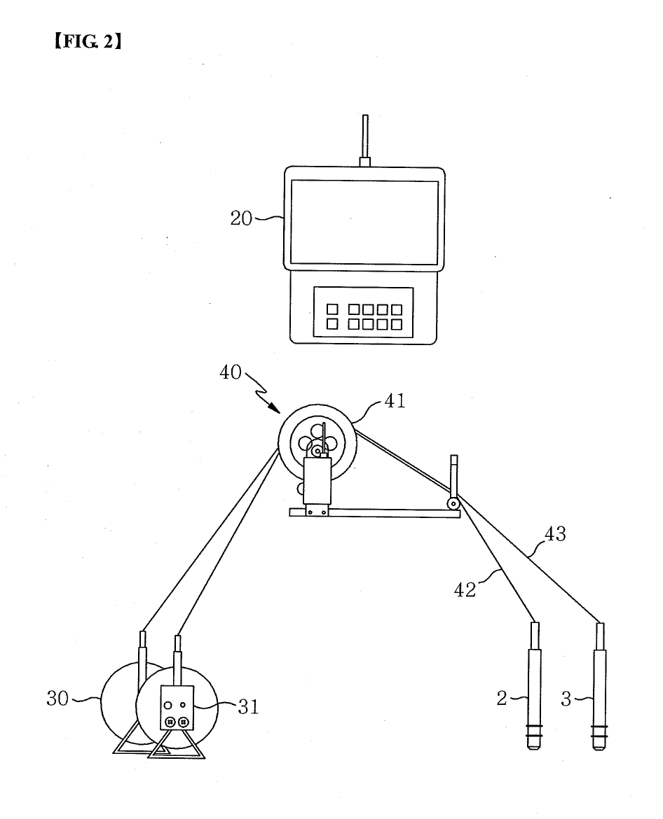

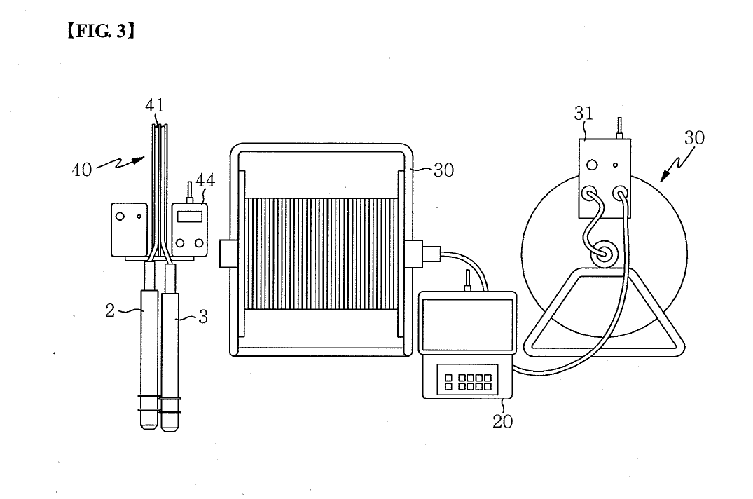

When the pulley 40 draws transmission and reception cables 42 and 43 connected to the transmission and reception probes 2 and 3 as illustrated in FIGS. 1 and 2, a roller 41 having two grooves for guiding cables rotates as illustrated in FIG. 3. A proximity sensor installed on a side of the pulley 40 senses the rotation of the roller 41 and transmits the sensed signal to a remote controller 44 illustrated in FIG. 3. The remote controller 44 converts the sensed signal to a trigger signal and transmits the trigger signal to a drum controller 31 installed on the drum 30 and finally wirelessly to the main body 20.

The pulley 40 includes a power board, a pulley board, a microcontroller (MCU) board, and an RF board, and the drum 30 includes the drum controller 31. The drum controller 31 includes a drum board with a sensor, for generating an ultrasonic wave at a transmitter and receiving an ultrasonic wave at a receiver, an MCU board, and an RF board, for wirelessly transmitting acquired data to the main body 20.

In this case, the transmitter of the drum 30 may amplify the amplitude of a signal, prior to transmission. Therefore, the transmitter can transmit a signal far and the receiver can receive even a weak signal. If the main body 20 fails to receive initially transmitted wireless data from the drum 30, the drum may retransmit the wireless data. The data received at the main body 30 may be represented as dots in a tomogram on a monitor.

A main controller of the body 20 includes a main board (arm-300 MHz), a power board, an interface board, and a ZigBee RF wireless board, for controlling the drum 30 and the remote controller 44 and checking data.

FIG. 3 illustrates important components according to the present invention. The pulley 40 with the remote controller 44, the drum 30 with the drum controller 31, connected to the pulley 40, the main body 20, and another cable drum 30 are illustrated in FIG. 3.

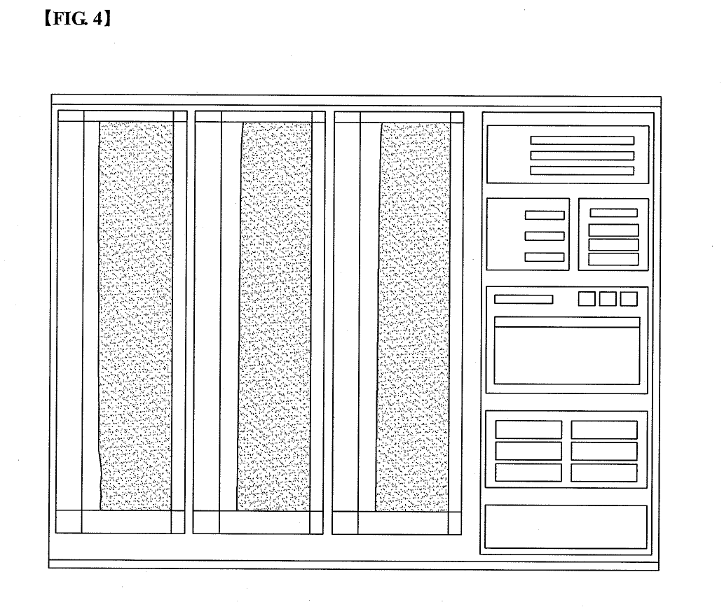

FIG. 4 illustrates an exemplary screen that displays a tomogram on the main body 20. Data received at the main body 20 may be plotted as dots in a tomogram on a monitor.

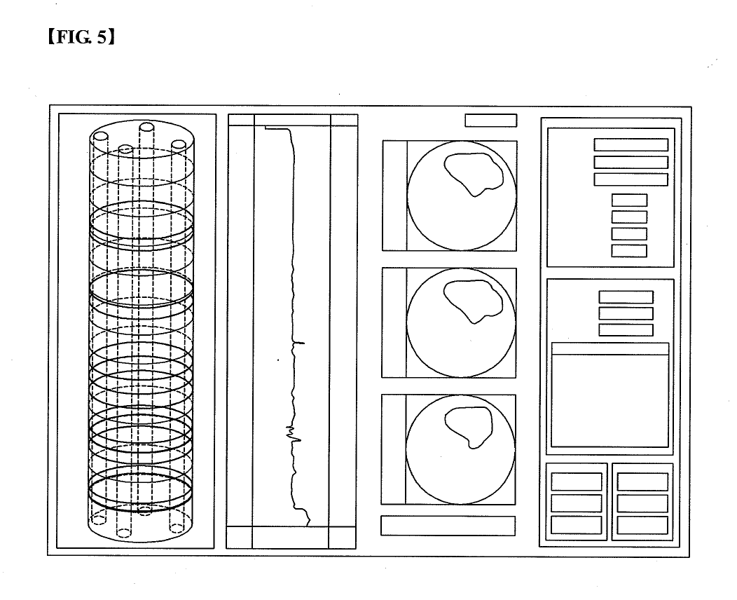

FIG. 5 illustrates an exemplary screen displaying a three-dimensional image of the concrete pile 1 analyzed at the main body 20.

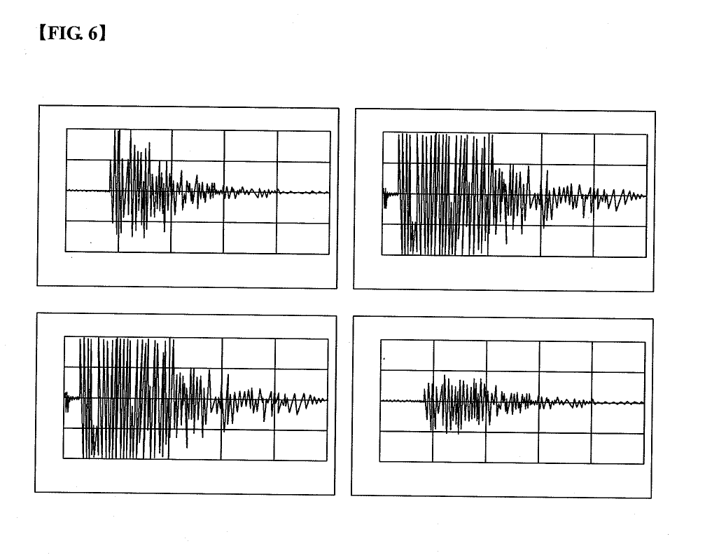

FIG. 6 illustrates exemplary measurement screens displayed on the main body 20 according to the present invention. As noted from FIG. 6, the main body 20 provides noiseless, clear displays of ultrasonic measurements on a screen.

As is apparent from the above description of the present invention, when a large concrete structure is inspected in a non-destructive manner, the inspected safety of the constructed structure can be quantified by digitization, thereby contributing to safety promotion.

Compared to a conventional wired inspection system which is difficult to install and with which inspection is difficult, the present invention can reduce an inspection time by 30% and the number of required on-site inspection persons from 3 to 2 through wireless communication with a main body. The resulting significant reduction of on-site labor cost and labor carrying testing cost can lead to improvement of throughput. According to the present invention, measured data can be displayed as a noiseless, clear image on the main body. Owing to digitization, a conventional analog thermal printer is not needed, a digital signature can be written to a touch screen, and measurement material can be stored and reused.

While conventionally, a screen is displayed on the main body after simple image processing and thus it is difficult and inconvenient to evaluate the soundness of concrete and analyze defect causes with the conventional screen, the present invention builds a database with all acquired data and analyzes the data quantitatively and elaborately, thereby determining the presence or absence of a defect and the degree of the defect and providing various information materials.

Further, the present invention can be designed to operate at low power through AC to DC conversion. Therefore, the volume, weight, and size of equipment can be reduced, thus making it convenient to move and use the equipment. According to the present invention, other signal drums and cables used for them can be eliminated, except for a drum used for transmission and reception cables.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A non-destructive inspection apparatus for detecting an internal defect in a concrete structure using ultrasonic waves, the non-destructive inspection apparatus comprising:
a transmission probe and a reception probe injected into tubes within a concrete pile;
a pulley connected to the transmission and reception probes by a cable;
a drum connected to the pulley and including a drum controller, for receiving data from the transmission and reception probes and the pulley and conducting wireless communication; and
a main body for receiving a signal from the drum controller of the drum and conducting wireless communication by ZigBee.

2. The non-destructive inspection apparatus of claim 1, wherein the pulley comprises:
a roller for rotating, while supporting the cable; and
a remote controller,
wherein the cable includes transmission and reception cables connecting the pulley to the transmission and reception probes, and
wherein the pulley comprises a roller, a proximity sensor installed on a side of the pulley senses rotation of the roller and transmits a sensed signal to the remote controller of the pulley, and the remote controller converts the sensed signal received from the proximity sensor to a trigger signal and transmits the trigger signal to the drum controller of the drum and finally to the main body wirelessly.

3. The non-destructive inspection apparatus of claim 1, wherein the pulley comprises a power board, a pulley board, a microcontroller (MCU) board, and a Radio Frequency (RF) board, and
wherein the drum controller of the drum includes a drum board with a sensor, for generating an ultrasonic wave at a transmitter and receiving an ultrasonic wave at a receiver, an MCU board, and an RF board, for wirelessly transmitting acquired data to the main body.

4. The non-destructive inspection apparatus of claim 1, wherein the main body converts received wireless signals to a tomogram and displays the tomogram on a screen.

5. The non-destructive inspection apparatus of claim 1, wherein the main body comprises a main controller including a main board (arm-300 MHz), a power board, an interface board, and a ZigBee RF wireless board, for controlling the drum and the remote controller, checking data, and displaying information about the concrete pile as a three-dimensional image.

6. The non-destructive inspection apparatus of claim 1, wherein the drum controller wirelessly transmits acquired data to the main body, checks transmission and reception using a check signal, and upon generation of data loss, retransmits lost data at a next transmission time.
